(19) United States
(12) Patent Application Publication
(10) Pub. No.: US 2008/0144495 A1
(43) Pub. Date: Jun. 19, 2008

(54) Early multilink traffic throttling for data communication node

(76) Inventor: Palathingal Frank, Santa Clara, CA (US)

Correspondence Address: Scot A. Reader, P.C., Suite 228, 1320 Pearl Street, Boulder, CO, 80302, US

(21) Appl. No.: 11/998,965

(22) Filed: Dec. 3, 2007

Related U.S. Application Data
(60) Provisional application No. 60/872,644, filed on Dec. 4, 2006.

(51) Int. Cl. H04L 12/24

(52) U.S. Cl. 370/230

(57) ABSTRACT

Early multilink traffic throttling for a data communication node throttles packets designated for forwarding on a multilink interface of a data communication node before distributing the packets to output queues associated with physical links of the multilink interface so as to prevent packet loss and reassembly problems caused by non-uniform operational characteristics of the physical links, such as disparate line rates. More particularly, early multilink traffic throttling verifies that all output queues associated with physical links of a multilink interface are ready to receive a packet before distributing the packet.

### CROSS-REFERENCE FOR RELATED APPLICATION

This application claims priority benefits under 35 U.S.C. 119(e) of U.S. Provisional Patent Application No. 60/872,644, filed on Dec. 4, 2006, the contents of which are incorporated herein by reference.

### BACKGROUND OF THE INVENTION

Multilink interfaces are logical interfaces that are configured on data communication nodes, such as routers and switches. A multilink interface aggregates multiple physical links into a single logical link. A multilink distributor on the data communication node selects among the active physical links of a multilink interface when forwarding data traffic designated for forwarding on the multilink interface using some form of a distribution method.

There are several known distribution methods employed by multilink distributors when selecting among the active physical links of a multilink interface. One method is round robin. In round robin, active physical links of the multilink interface are selected for forwarding packets on the multilink interface in a round robin fashion. All active physical links are cycled through and every link is selected to receive one packet before the cycle is repeated. Another method is weighted round robin. In weighted round robin, round robin selection is carried out with consideration given to the bandwidth of the active physical links. Links are favored and disfavored based on their bandwidth, thereby leading to selection of faster links with higher frequency and slower links with lower frequency. Another method is fragmentation. Fragmentation is the method of breaking up a packet into equal size fragments and distributing the equal size fragments of the packet across all of the active physical links. The number of fragments and the fragment size is determined by the number of links.

Multilink interfaces sometimes include physical links that operate at different speeds. For example, some multilink interfaces are made up of physical links on different line cards of a data communication node that support different line rates. When this is the case, a distribution problem can arise in the forwarding path. As mentioned, packets designated for forwarding on a multilink interface are passed to the multilink distributor and either distributed as whole packets or as fragments to output queues associated with the active physical links. However, unless the weighted round robin algorithm with appropriate weights is used, there will be a log time between line transmission of packets and fragments on fast links and line transmission of packets and fragments on the slow links. Because of this lag, packets and fragments begin to build-up in the output queues of the slower links while the faster links successfully transmit the packets and fragments on the line. Moreover, at the receiving end, the receiving data communication node begins to queue packets and fragments arriving on the faster links but is unable to process the packets and reassemble the fragments because they arrive out of sequence. The receiving data communication node thus has to wait for the packets and fragments on the slower links to arrive before such processing and reassembly can be carried out. This causes the input queues on the receiving data communication node to fill up, and once these input queues are full they begin to drop packets and fragments arriving on the line. Accordingly, there is a need to better control traffic designated for forwarding on multilink interfaces to reduce packet loss and packet reassembly problems.

### SUMMARY OF THE INVENTION

The present invention, in a basic feature, provides early multilink traffic throttling for a data communication node. In early multilink traffic throttling, packets designated for forwarding on a multilink interface of a data communication node are throttled before distributing the packets to output queues associated with physical links of the multilink interface so as to prevent packet loss and reassembly problems caused by non-uniform operational characteristics of the physical links, such as disparate line rates. More particularly, early multilink traffic throttling verifies that all output queues associated with physical links of a multilink interface are ready to receive a packet before distributing the packet.

In one aspect of the invention, a data communication node having a multilink interface comprises a plurality of physical links associated with the multilink interface, a plurality of output queues associated with the plurality of physical links, respectively, a multilink distributor adapted to distribute packets designated for forwarding on the multilink interface among the plurality of output queues and a multilink throttling engine adapted to control release of the packets from an input queue to the multilink distributor, wherein a packet is released from the input queue to the multilink distributor only in response to an indication that all of the output queues within the plurality are ready to receive a packet.

In some embodiments, the multilink distributor is adapted to distribute whole packets to selected ones of the plurality of output queues in accordance with a predetermined load balancing algorithm.

In some embodiments, the multilink distributor is adopted to fragment pockets and distribute a fragment of all packets to all of the output queues within the plurality.

In some embodiments, at least two of the physical links reside on different line cards of the data communication node.

In some embodiments, at least two of the physical links operate at different line rates.

In some embodiments, the indication is generated at least in part by monitoring the plurality of output queues for readiness to receive a packet.

In some embodiments, the indication is generated at least in part by feedback supplied in response to determinations of readiness of the plurality of output queues to receive a packet.

In some embodiments, the indication is generated at least in part by toggling throttling flags indicative of readiness of the plurality of output queues to receive a packet.

In some embodiments, the throttling engine is adopted check throttling flags indicative of readiness of the plurality of output queues to receive a packet and to release a packet from the input queue to the multilink distributor only in response to an indication in the throttling flags that all of the output queues within the plurality are ready to receive a packet.

In another aspect of the invention, a method for early multilink traffic throttling comprises the steps of checking a plurality of output queues associated with a multilink interface for an indication of readiness to receive a packet, inhibiting release of a packet from an input queue to a selected one of the output queues in response to an indication that at least one but not all of the output queues within the plurality are ready to receive a packet and releasing a packet from the input queue to the selected one of the output queues in response to an indication that all of the output queues within the plurality are ready to receive a pocket.

In some embodiments, the selected one of the output queues is selected in accordance with a predetermined load balancing algorithm.

In some embodiments, the indication is generated at least in part by monitoring the plurality of output queues for readiness to receive a pocket.

In some embodiments, the indication is generated at least in part by feedback supplied in response to determinations of readiness of the plurality of output queues to receive a packet.

In some embodiment, the indication is generated at least in part by toggling throttling flags indicative of readiness of the plurality of output queues to receive a packet.

In another aspect of the invention, a method for early multilink traffic throttling comprises the steps of checking a plurality of output queues associated with a multilink interface for readiness to receive a packet and distributing a packet to a selected one of the output queues only upon verifying that all of the output queues are ready to receive a packet.

In some embodiments, the distributing step comprises selecting the selected one of the output queues in accordance with a predetermined load balancing algorithm.

In some embodiments, the method further comprises the step of monitoring the plurality of output queues for readiness to receive the packet.

In some embodiments, the method further comprises the step of supplying feedback in response to determinations of readiness of the plurality of output queues to receive the packet.

In some embodiments, the method further comprises the step of toggling multilink throttling flags indicative of readiness of the plurality of output queues to receive the packet.

These and other aspects of the invention will be better understood by reference to the detailed description in conjunction with the drawing that is briefly described below. Of course, the invention is defined by the appended claims.

### BRIEF DESCRIPTION OF THE DRAWINGS

FIG. 1 shows data communication nodes communicatively coupled by multiple physical links associated with a multilink interface.

FIG. 2 shows a multilink interface operative within a data communication node in some embodiments of the invention.

FIG. 3 shows a method for early multilink traffic throttling in some embodiments of the invention.

### DETAILED DESCRIPTION OF A PREFERRED EMBODIMENT

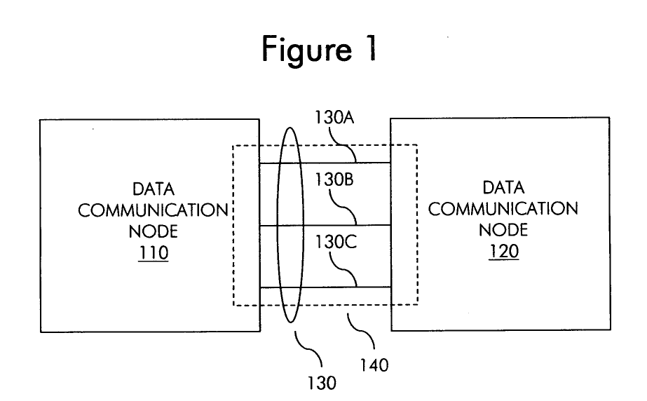

In FIG. 1, data communication nodes 110, 120, such as data communication switches, routers, bridges, servers or clients, are shown communicatively coupled by multiple physical links 130A, 130B, 130C. Physical links 130A, 130B, 130C are associated with a multilink interface 140 that aggregates physical links 130A, 130B, 130C into a single logical link 130. The association of physical links 130A, 130B, 130C with multilink interface 140 offers advantages in terms of, for example, added bandwidth for traffic flows on multilink interface 140 and redundancy in the event of failure of one of more of physical links 130A, 130B, 130C.

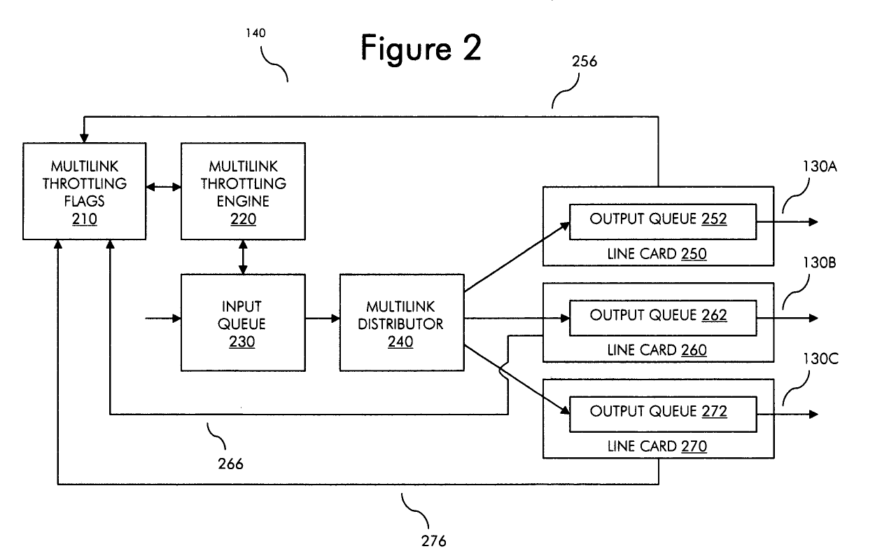

In FIG. 2, the transmitting end of multilink interface 140, which is operative within data communication node 110, is shown in some embodiments of the invention to include a multilink throttling engine 220 communicatively coupled between multilink throttling flags 210 and an input queue 230. Input queue 230 is communicatively coupled with a multilink distributor 240 which is in turn communicatively coupled with output queues 252, 262, 272 that are associated with physical links 130A, 130B, 130C, respectively. Output queues 252, 262, 272 are resident on line cards 250, 260, 270, respectively, and temporarily store packets or packet fragments awaiting transmission on links 130A, 130B, 130C, respectively. Links 130A, 130B, 130C may operate at different line rates. In some embodiments, output queues 252, 262, 272 are dedicated to links 130A, 130B, 130C. In other embodiments, output queues 252, 262, 272 may additionally store packets or packet fragments for transmission on physical links other than links 130A, 130B, 130C. Naturally, the illustrated number of line cards, output queues and physical links is merely representative. A multilink interface operative in accordance with the invention may generally have one or more line cards, two or more output queues and two or more physical links.

Throttling flags 210 convey ready status, indicating whether output queues 252, 262, 272 are ready to receive the next packet or fragment. Each one of output queues 252, 262, 272 has a dedicated one of flags 210 that is toggled to convey ready status. If the flag for an output queue is set, which may be indicated by a dedicated bit for the output queue having a value of “1”, the output queue is indicated to be unprepared to receive the next packet or fragment. If the flag for an output queue is clear, which may be indicated by a dedicated bit for the output queue having a value of “0”, the output queue is indicated to be prepared to receive the next pocket or fragment. Flogs 210 are updated by line cords 160, 170, 180 via feedback lines 166, 176, 186, respectively. Such updates may be periodic or event-driven. In some embodiments, flogs 210 are updated only when the ready status of an output queue changes, that is, from “ready” to “not ready”, or from “not ready” to “ready”.

Throttling engine 220 conditions release of pockets from input queue 230 to multilink distributor 240 on the ready state of throttling flogs 210. Throttling engine 220 controls the release of pockets designated for multilink interface 140 from input queue 230 to multilink distributor 240. Prior to releasing the next pocket to multilink distributor 240, throttling engine 220 consults throttling flogs 210. Throttling engine 220 releases the packet to multilink distributor 240 if all flogs 210 are clear; however, throttling engine 220 inhibits release of the packet if not all flogs 210 are clear. For example, if the ones of flogs 210 associated with output queues 252 and 262 are clear but the one of flags 210 associated with output queue 272 is not clear, forwarding engine 220 prevents release. Forwarding engine 220 thereafter periodically rechecks flags 210 and only when forwarding engine 220 verifies that all flags 210 are clear releases the packet to multilink distributor 240. It will be appreciated that by postponing release of a packet until all flags 210 are clear, packets and fragments are distributed to output queues 252, 262, 272 only as fast as the slowest physical link associated with multilink interface 140 can handle them. Packet loss at the transmitting end and receiving end of multilink interface 140, and reassembly problems at the receiving end of multilink interface 140, are thereby avoided. In some embodiments, throttling engine 220 is a packet processing engine that has forwarding path resolution capabilities as well as throttling capabilities.

Input queue 230 temporarily stores inbound packets, which may be of fixed or variable length, while such packets await action by throttling engine 220. Packets may be, for example, Internet Protocol (IP) datagrams, Ethernet frames or Asynchronous Transfer Mode (ATM) cells. In some embodiments, input queue 230 is a shared resource that stores packets destined for multilink interface 140 as well as other logical or physical interfaces.

Multilink distributor 240 distributes packets released from input queue 230 across output queues 252, 262, 272. Multilink distributor 240 receives packets released from input queue 230 under control of throttling engine 220 and selects output queues 252, 262, 272 for receiving the packets or fragments of the packets based on a predetermined distribution algorithm. In some embodiments, multilink distributor 240 distributes whole pockets to a selected one of output queues 252, 262, 272 in accordance with a predetermined load balancing algorithm, such as round robin, weighted round robin or an algorithm that distributes packets based on address hashing. In other embodiments, multilink distributor 240 fragments packets and distributes a fragment of each packet to all output queues 252, 262, 272. In some embodiments, multilink distributor 240 encapsulates packets prior to distribution.

Output queues 252, 262, 272 temporarily store packets distributed by multilink distributor 240 while such packets await release on physical links 130A, 130B, 130C, respectively. Output queues 252, 262, 272 are operative on different line cards 250, 260, 270 and in some embodiments have physical links 130A, 130B, 130C that are operative at different line rates. Output queues 252, 262, 272 are serviced by their respective line cards 250, 260, 270 to transmit packets on their respective physical links 130A, 130B, 130C.

Line cords 250, 260, 270 independently monitor their respective output queues 252, 262, 272 to determine whether their respective output queues 252, 262, 272 are ready to receive an additional pocket. In some embodiments, the determination of readiness is based on output queue fullness, for example, whether the output queue con presently accommodate a pocket or a fragment of a maximum transfer unit size. In response to determinations of readiness of their respective output queues 252, 262, 272 to receive a pocket, line cords 250, 260, 270 toggle throttling flogs 210 via feedback lines 256, 266, 276. For example, if output queue 252 was previously prepared to receive a packet and is now unprepared, line card 250 may supply feedback via feedback line 256 causing to be set the one of throttling flags 210 that represents output queue 252 and its associated physical link 130A. When output queue 252 subsequently returns to the ready state (which may happen, for example, once a packet or fragment has been transmitted from output queue 252 on link 130A), line cord 250 may supply feedback via feedback line 256 causing to be cleared the one of throttling flogs 210 that represents output queue 252 and its associated physical link 130A.

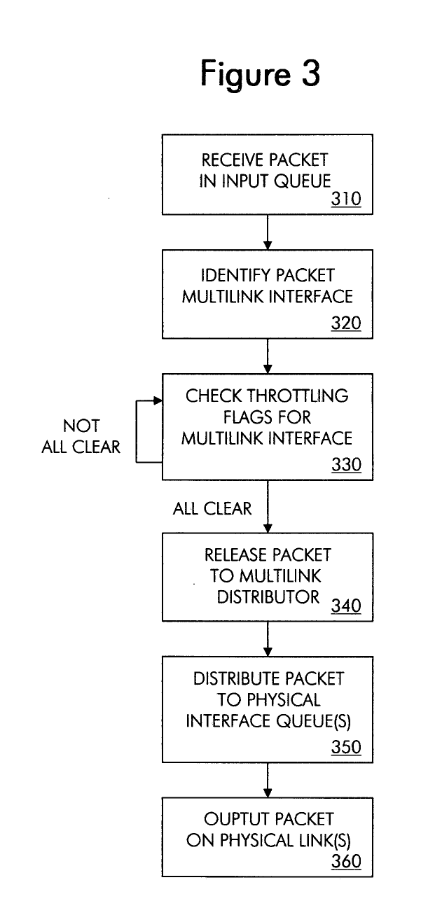

In FIG. 3, a method for early multilink traffic throttling is shown in some embodiments of the invention. A pocket is received in input queue 230 (310). Throttling engine 220 identifies the packet to multilink interface 140 (320). When the packet is ready for servicing, throttling engine 220 checks throttling flogs 210 to determine whether all output queues 252, 262, 272 are prepared to receive the packet as indicated by all flogs 210 being clear (330). If not all flags 210 are clear, the check is repeated in-loop. If, however, all flogs 210 are clear, throttling engine 220 releases the pocket to multilink distributor 240 (340). Multilink distributor 240 either distributes the pocket to one of output queues 252, 262, 272 selected in accordance with a predetermined distribution algorithm, or fragments the packet and distributes fragments of the packet to all of the output queues 252, 262, 272 (350). The packet is subsequently output on one or more of physical links 130A, 130B, 130C pursuant to servicing of the one or more of output queues 252, 262, 272 by one or more of line cards 250, 260, 270 (360).

Elements of multilink interface 140 described herein may be implemented in custom logic, such as application specific integrated circuits (ASICs), programmable logic, such as network processors, general purpose logic, such as general purpose processors executing software, or a combination thereof. It will be appreciated by those of ordinary skill in the art that the invention can be embodied in other specific forms without departing from the spirit or essential character hereof. The present description is therefore considered in all respects to be illustrative and not restrictive. The scope of the invention is indicated by the appended claims, and all changes that come with in the meaning and range of equivalents thereof are intended to be embraced therein.

What is claimed is:

1. A data communication node having a multilink interface, comprising:
a plurality of physical links associated with the multilink interface;
a plurality of output queues associated with the plurality of physical links, respectively;
a multilink distributor adopted to distribute packets designated for forwarding on the multilink interface among the plurality of output queues; and
a multilink throttling engine adapted to control release of the packets from an input queue to the multilink distributor, wherein a packet is released from the input queue to the multilink distributor only in response to an indication that all of the output queues within the plurality are ready to receive a packet.

2. The data communication node of claim 1, wherein the multilink distributor is adapted to distribute whole packets to selected ones of the plurality of output queues in accordance with a predetermined load balancing algorithm.

3. The data communication node of claim 1, wherein the multilink distributor is adapted to fragment packets and distribute a fragment of all packets to all of the output queues within the plurality.

4. The data communication node of claim 1, wherein at least two of the physical links reside on different line cards of the data communication node.

5. The data communication node of claim 1, wherein at least two of the physical links operate at different line rates.

6. The data communication node of claim 1, wherein the indication is generated at least in part by monitoring the plurality of output queues for readiness to receive a packet.

7. The data communication node of claim 1, wherein the indication is generated at least in part by feedback supplied in response to determinations of readiness of the plurality of output queues to receive a packet.

8. The data communication node of claim 1, wherein the indication is generated at least in part by toggling throttling flags indicative of readiness of the plurality of output queues to receive a packet.

9. The data communication node of claim 1, wherein the throttling engine is adapted check throttling flags indicative of readiness of the plurality of output queues to receive a packet and to release a packet from the input queue to the multilink distributor only in response to an indication in the throttling flags that all of the output queues within the plurality are ready to receive a packet.

10. A method for early multilink traffic throttling, comprising the steps of:
checking a plurality of output queues associated with a multilink interface for an indication of readiness to receive a packet;
inhibiting release of a packet from an input queue to a selected one of the output queues in response to an indication that at least one but not all of the output queues within the plurality are ready to receive a packet; and
releasing a packet from the input queue to the selected one of the output queues in response to an indication that all of the output queues within the plurality are ready to receive a packet.

11. The method of claim 10, wherein the selected one of the output queues is selected in accordance with a predetermined load balancing algorithm.

12. The method of claim 10, wherein the indication is generated at least in part by monitoring the plurality of output queues for readiness to receive a packet.

13. The method of claim 10, wherein the indication is generated at least in port by feedback supplied in response to determinations of readiness of the plurality of output queues to receive a packet.

14. The method of claim 10, wherein the indication is generated at least in part by toggling throttling flags indicative of readiness of the plurality of output queues to receive a packet.

15. A method for early multilink traffic throttling, comprising the steps of:
checking a plurality of output queues associated with a multilink interface for readiness to receive a packet; and
distributing a packet to a selected one of the output queues only upon verifying that all of the output queues are ready to receive a packet.

16. The method of claim 15, wherein the distributing step comprises selecting the selected one of the output queues in accordance with a predetermined load balancing algorithm.

17. The method of claim 15, further comprising the step of monitoring the plurality of output queues for readiness to receive the packet.

18. The method of claim 15, further comprising the step of supplying feedback in response to determinations of readiness of the plurality of output queues to receive the packet.

19. The method of claim 15, further comprising the step of toggling multilink throttling flags indicative of readiness of the plurality of output queues to receive the packet.
